(19) United States
(12) Patent Application Publication
(10) Pub. No.: US 2002/0121856 A1
(43) Pub. Date: Sep. 5, 2002

(54) Florescent lamps with extended service life

(75) Inventor: Chun-Hui Tsai, Hsinchu (TW)

Correspondence Address: Bo-In Lin, 13445 Mandoli Drive, Los Altos Hills, CA, 94022, US

(73) Assignee: DELTA OPTOELECTRONICS, INC.

(21) Appl. No.: 10/090,101

(22) Filed: Mar. 2, 2002

Related U.S. Application Data
(60) Provisional application No. 60/272,945, filed on Mar. 2, 2001.

(51) Int. Cl. H01J 1/62

(52) U.S. Cl. 313/491

(57) ABSTRACT

The present invention discloses a fluorescent lamp that includes a cathode electrode covered with an electron-emitting layer composed of a nanotube layer. In a preferred embodiment, the nanotube layer in the fluorescent lamp is a carbon nanotube layer. In another preferred embodiment, the fluorescent lamp further includes a positive electrode formed as a thin film layer covering an external tube surface of the fluorescent tube. In another preferred embodiment, the positive electrode for drawing and directing electrons emitted from the nanotube layer is a net electrode with openings for the free electrons to pass through.

This Application is a Formal Application claims a Priority Date of Mar. 2, 2001, benefited from a previously filed Provisional Application No. 60/272,945 by the same Applicant of this Application.

### BACKGROUND OF THE INVENTION

1. Field of the Invention

This invention relates generally to florescent lamps. More particularly, this invention relates to an improved florescent lamp provided with carbon nanotube (CNT) cathode electrode(s) for achieving extended service life.

2. Description of the Prior Art

Conventional fluorescent lamps are confronted with the difficulties that the service life of a hot-cathode lamp is limited due to the depletion of an electron emitting layer, e.g., BaO layer, commonly employed for providing free electrons emitted from this layer for bombarding a phosphor layer to generate fluorescent light. As the electron emitter layer depleted continuously during operation, the fluorescent lamp becomes difficult to turn on and a darkened lamp surface appears when turned on due to fewer free electrons for bombarding the phosphor layer covered the inner surface of the fluorescent tube to emit light.

Referring to FIGS. 1A and 1B for two conventional fluorescent lamps. FIG. 1A shows a fluorescent lamp 10 implemented with a hot cathode electrode 15. With electric current passing through the cathode electrode 15, free electrons will be produced and the free electrons bombard the tube 20 covered with phosphor particles for emitting light. The cathode electrode 15 of the fluorescent lamp 10 is covered with a BaO layer. The BaO layer is deposited on the cathode electrode 15 to lower the voltage required to operate the fluorescent lamp because the BaO has a lower work function for electron emission. However, the BaO is continuously depleted during the operation of the fluorescent lamp 10. The useful life of the fluorescent lamp 10 is limited due to as the depletion of the BaO layer.

FIG. 1B is another type of conventional fluorescent lamp 30 that operates with cold cathode electrodes 35. High voltage is applied to two metal electrodes 35 enclosed in a tube 40 to produce plasma for emitting light. Without being limited by a depleting layer of electron emitting layer as that of lamp 10, the service life of this type of fluorescent lamp is longer. However, the plasma generation of this fluorescent lamp 30 consumes more power and requires higher voltage operation and becomes less economical for long-term operation. Specifically, the illumination efficiency is approximately 50 cl/watt compared to the illumination rate of 60 cl/watt achievable by a hot-cathode fluorescent lamp.

Therefore, there is a need in the art to provide an improved fluorescent lamp that is more economical to operate with extended service life. A technique to resolve the difficulties caused by depletion of the electron-emitting layer is necessary. It is desirable that the fluorescent lamp can be provided to achieve an extended service life comparable to the cold-cathode fluorescent lamp while the operation voltage, tube configuration and illumination efficiency can be made similar to that of a fluorescent lamp employing the hot cathode electrodes.

### SUMMARY OF THE PRESENT INVENTION

Therefore, it is an object of the present invention to provide a novel cathode electrode for a fluorescent lamp to provide extended service life such that the difficulties of limited service life as that faced by a conventional hot-cathode fluorescent lamp can be resolved.

Specifically, it is an object of the present invention to provide a carbon nanotube (CNT) cathode electrode to a hot-cathode fluorescent lamp for generating free electrons. The carbon nanotube electrodes can operate for extended period without being limited by the difficulties of the depletion of electron emitting layer. The carbon nanotube electrode implemented in a fluorescent lamp of this invention takes advantage of a special configuration of a carbon nanotube (CNT) electrode. Specifically, the CNT electrode has a great number of nanotubes each has a sharp end. Each of these nanotubes is able to induce a field discharge from the sharp end from each of the nanotubes to generate free electrons. Because of the great number of these nanotubes, the concerns of total depletion of these nanotubes are resolved and the service life of the fluorescent lamp is significantly extended. Furthermore, the efficiency of power utilization is also improved because less amount of energy would be required to induce the discharge of free electrons from these nanotubes.

Briefly, in a preferred embodiment, the present invention discloses a fluorescent lamp that includes a cathode electrode covered with an electron-emitting layer composed of a nanotube layer. In a preferred embodiment, the nanotube layer in the fluorescent lamp is a carbon nanotube layer. In another preferred embodiment, the fluorescent lamp further includes a positive electrode formed as a thin film layer covering an external tube surface of the fluorescent tube. In another preferred embodiment, the positive electrode for drawing and directing electrons emitted from the nanotube layer is a net electrode with openings for the free electrons to pass through.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A and 1B are cross sectional views of two conventional fluorescent lamps;

FIG. 2A is a cross sectional view of a new fluorescent lamp with novel carbon nanotube layer cover a cathode electrode of this invention;

FIG. 2B is a magnification transmission electron micro-graph (TEM) image of a portion of the carbon nanotube layer employed in a fluorescent lamp of this invention;

FIG. 3 is a cross sectional view of a new fluorescent lamp with an electrode covered with carbon nanotube layer and a net electrode for directing and passing the free electrons emitted from the CNT layer.

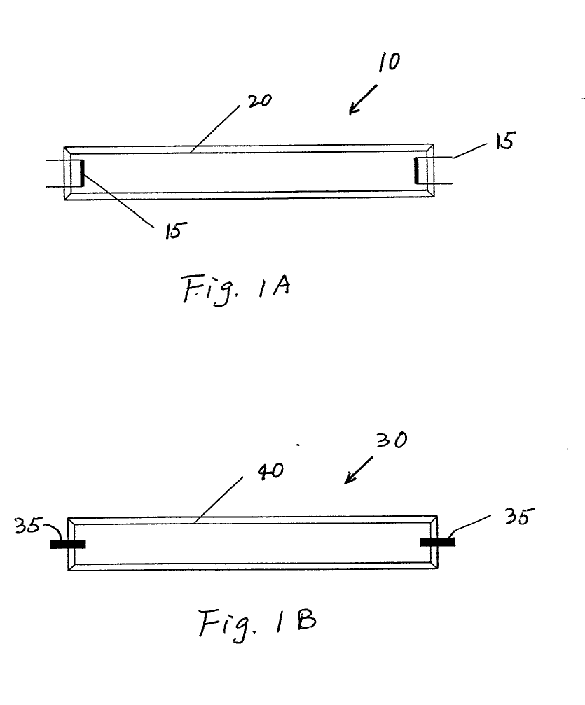

### DETAILED DESCRIPTION OF THE PREFERRED EMBODIMENT

FIG. 2A is a cross sectional view of a single electrode fluorescent lamp 100 as an example of a preferred embodiment of this invention. The fluorescent lamp 100 is enclosed in a glass fluorescent-tube 105 that has a layer of phosphor particles 110 covers the inner surface of the glass fluorescent tube 105. A layer 125 composed of a carbon nanotube (CNT) emitter covers the front end of a cathode electrode 120. A thin metal film 130 is formed covering a portion of the outer surface of the glass fluorescent tube 105. When a negative voltage is applied to the cathode electrode 120, a voltage difference is formed between the nanotube emitter layer 125 and the metal film layer 130. The carbon nanotube (CNT) layer has a plurality of nanotube emitter, each of these emitters can emit electrons with a low negative voltage applied on the cathode 120. The electrons emitted from the cathode electrode 120 from the nanotube emitter layer 125 bombard the phosphor particle layer 110 to generate fluorescent light. Referring to FIG. 2B for a magnification transmission electron micro-graph (TEM) image of a portion of the carbon nanotube emitter layer 125 that has a plurality of nanotubes 128 shown as fine wires in the TEM image wherein these nanotubes extends from the surface of the emitter layer 125. Because of the sharp needle shape, these nanotubes 128 can discharge electrons from the sharp front end easily with a very small voltage applied to the CNT layer 125. As there are large number of nanotubes 128, the useful service life of the fluorescent lamp is significant extended without being limited by the short lift span of a conventional starter electrode made of BaO.

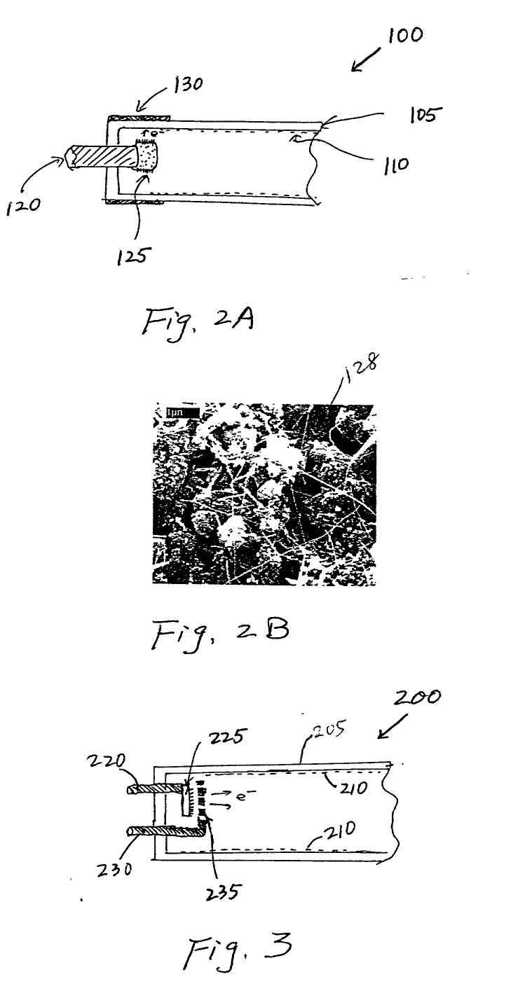

FIG. 3 is a cross sectional view of a dual-electrode fluorescent lamp 200 as an example of an alternate preferred embodiment of this invention. The fluorescent lamp 200 is enclosed in a glass fluorescent-tube 205 that has a layer of phosphor particles 210 covers the inner surface of the glass fluorescent tube 205. A layer 225 composed of a carbon nanotube (CNT) emitter covers an emitting end of a cathode electrode 220. A second metal electrode 230 is formed as a net electrode having a plurality of openings 235 disposed near the emitting 225 at the emitting end of the cathode electrode 220. When a negative voltage is applied to the cathode electrode 220, or a positive voltage is applied to the net electrode 230, a voltage difference is formed between the nanotube emitter layer 225 and the net electrode 230. The carbon nanotube (CNT) layer has a plurality of nanotube emitters; each of these emitters emits electrons when a low voltage difference is applied between the CNT layer 225 and the net electrode 230. The electrons emitted from the cathode electrode 220 from the nanotube emitter layer 225 pass through the opening 235 of the net electrode 230 and bombard the phosphor particle layer 210 to generate fluorescent light. Referring to FIG. 2B again for the enlarged cross sectional view of the carbon nanotube emitter layer 225 that has a plurality of nanotubes 128 extends from the surface of the emitter layer 225. Because of the sharp needle shape, these nanotubes 128 can discharge electrons from the sharp front end easily with a very small voltage difference applied between the CNT layer 225 and the net electrode 230. As there are large number of nanotubes 128 formed on the CNT layer 225, the useful service life of the fluorescent lamp 200 is significant extended without being limited by a relative short lift span of a conventional starter electrode made of conventional electron emitting layer.

According to FIGS. 2 and 3, this invention discloses a fluorescent lamp that includes a cathode electrode covered with an electron-emitting layer composed of a nanotube layer. In a preferred embodiment, the nanotube layer in the fluorescent lamp is a carbon nanotube layer. In another preferred embodiment as that shown in FIG. 2A, the fluorescent lamp further includes a positive electrode formed as a thin film layer covering an external tube surface of the fluorescent tube. In another preferred embodiment, as that shown in FIG. 3, the positive electrode for drawing and directing electrons emitted from the nanotube layer is a net electrode with openings for the free electrons to pass through.

In essence this invention discloses a light emitting device that includes: a nanotube layer 125 provided for emitting a plurality of charged particles, e.g. a plurality of electrons. The light-emitting device further comprises a charged-particle activated light emitting surface 110 provided for receiving the charged-particles to activate a light emission, e.g., a florescent light. In a preferred embodiment, the light emitting device further includes a charge particle draw means for drawing the charged particles emitted from the nanotube layer to bombard the charged-particle activated light-emitting surface. In a specific embodiment, the charge particle draw means comprising electrodes 120 and 130 for applying an electric field for drawing the charged particles emitted from the nanotube layer to bombard the charged-particle activated light-emitting surface. In another specific embodiment, the charged particle activated light-emitting surface 110 comprises a surface coated with phosphor particles for emitting a florescent light when bombarded with the charged particles.

In summary, this invention further discloses a method for making a light-emitting device. The method includes a step of emitting a plurality of charged particles from a nanotube layer. The method further includes a step of receiving the charged particles onto a charged particle activated light emitting surface to activate a light emission. In a preferred embodiment, the method further includes a step of employing a charge particle draw means for drawing the charged particles emitted from the nanotube layer to bombard the charged-particle activated light-emitting surface. In another embodiment, the method, the step of employing the charge particle draw means comprising a step of applying an electric field for drawing the charged particles emitted from the nanotube layer to bombard the charged-particle activated light-emitting surface. In another preferred embodiment, the step of providing the charged particle activated light-emitting surface comprises a step of coating a surface with a layer of phosphor particles for emitting a florescent light when bombarded with the charged particles.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A fluorescent lamp comprising:
a cathode electrode covered with an electron emitting layer comprising a nanotube layer.

2. The fluorescent lamp of claim 1 wherein:
said nanotube layer comprising a carbon nanotube (CNT) layer.

3. The fluorescent lamp of claim 1 further comprising:
a positive electrode formed as a thin film layer covering an external tube surface of said fluorescent lamp.

4. The fluorescent lamp of claim 1 further comprising:
a positive electrode formed as a net electrode disposed near said cathode facing said electron emitting layer for drawing and directing electrons emitted from said nanotube layer wherein said net electrode having a plurality of openings for allowing said electrons to pass through.

5. A fluorescent lamp comprising:
a cathode electrode covered with an electron emitting layer comprising a nanotube layer wherein said nanotube layer is a carbon nanotube (CNT) layer;
a positive electrode for applying an electric field for drawing a plurality of electrons emitted from said CNT layer to bombard a phosphor layer for emitting a fluorescent light.

6. The fluorescent lamp of claim 5 further wherein:
said positive electrode is formed as a thin film layer covering an external tube surface of said fluorescent lamp.

7. The fluorescent lamp of claim 6 wherein:
said positive electrode formed as a net electrode disposed near said cathode facing said electron emitting layer for drawing and directing electrons emitted from said nanotube layer wherein said net electrode having a plurality of openings for allowing said electrons to pass through.

8. A light emitting device comprising:
a nanotube layer provided for emitting a plurality of charged particles;
a charged-particle activated light emitting surface provided for receiving said charged-particles to activate a light emission.

9. The light emitting device of claim 8 further comprising:
a charge particle draw means for drawing said charged particles emitted from said nanotube layer to bombard said charged-particle activated light-emitting surface.

10. The light-emitting device of claim 9 wherein:
said charge particle draw means comprising electrodes for applying an electric field for drawing said charged particles emitted from said nanotube layer to bombard said charged-particle activated light-emitting surface.

11. The light-emitting device of claim 8 wherein:
said charged-particle activated light-emitting surface comprising a surface coated with a phosphor particles for emitting a florescent light when bombarded with said charged particles.

12. A method for making a light emitting device comprising:
emitting a plurality of charged particles from a nanotube layer;
providing a charged-particle activated light emitting surface for receiving said charged-particles to activate a light emission.

13. The method of claim 12 further comprising:
employing a charge particle draw means for drawing said charged particles emitted from said nanotube layer to bombard said charged-particle activated light-emitting surface.

14. The method of claim 13 wherein:
said step of employing said charge particle draw means comprising a step of applying an electric field for drawing said charged particles emitted from said nanotube layer to bombard said charged-particle activated light-emitting surface.

15. The method of claim 12 wherein:
said step of providing said charged-particle activated light-emitting surface comprising a step of coating a surface with a layer of phosphor particles for emitting a florescent light when bombarded with said charged particles.
